(19) United States
(12) Patent Application Publication
(10) Pub. No.: US 2015/0061500 A1
(43) Pub. Date: Mar. 5, 2015

(54) Wireless Daylight and Occupancy Controlled Lighting Control Module and Lighting Apparatus

(71) Applicant: VERIFIED ENERGY LLC, Rochester, NY (US)

(72) Inventor: Thomas I. Yeh, Rochester, NY (US)

(73) Assignee: VERIFIED ENERGY LLC, Rochester, NY (US)

(21) Appl. No.: 14/450,590

(22) Filed: Aug. 4, 2014

Related U.S. Application Data
(60) Provisional application No. 61/861,857, filed on Aug. 2, 2013.

(51) Int. Cl. H05B 37/02; H05B 41/36; H05B 33/08

(52) U.S. Cl. CPC H05B 37/0272; H05B 37/0218; H05B 37/0236; H05B 33/0854; H05B 41/36
USPC 315/149; 315/312

(57) ABSTRACT

Disclosed is a means to implement wireless daylight control of light level for a group of lighting fixtures configured to operate in the same light zone, by measuring the amount of natural daylight available in the immediate areas using a photo sensor connected to a wireless control module and wirelessly transmitting the photo sensor output or a derived value based on the photo sensor output. The wireless control can be further supplemented with occupancy control, manual adjustments and automated computerized control of the lighting fixtures configured to operate in the same light zone.

### CROSS-REFERENCE TO RELATED PATENT APPLICATIONS

Priority for this patent application is based upon provisional patent application 61/861,857 (filed on Aug. 2, 2013). The disclosure of this United States patent application is hereby incorporated by reference into this specification.

### TECHNICAL FIELD

The current invention relates to lighting control systems for homes, offices, commercial spaces, parking, exterior perimeter and public areas; more particularly to wirelessly incorporating photo sensors into the lighting control systems for controlling lighting operation during daylight hours.

### BACKGROUND OF THE INVENTION

Daylight control of lighting system illumination levels requires adjusting the output of a lighting fixture according to the amount of natural daylight in the immediate areas of the lighting fixture. Wired systems to control illumination level are well known in the art.

One possible scheme to accomplish this function is by integrating a photo sensor into a lighting fixture equipped with a light source to detect the level of natural light near the lighting fixture. Internally to the lighting fixture the photo sensor is connected to a light driver (e.g. a fluorescent ballast) or, if needed, a suitably designed intermediate device taking the input from the photo sensor and outputs a control signal. The photo sensor outputs ambient light level electrically to the light driver herein assuming the function if required by the intermediate device. The light driver then adjusts the level of electrical power delivered to the connected light source to affect the light level produced by the lighting fixture according to a preprogrammed algorithm. By lowering light output when natural ambient light is available in abundance and increasing light output when natural ambient light is low or not available, energy savings are achieved compared to the alternative practice of maintaining constant light output regardless of the availability of natural light. This method is referred to as “Daylight Harvesting” or “Daylight Control” or simply as “Daylighting”.

FIG. 1 illustrates one common implementation of daylight control with a fluorescent lighting fixture. In FIGS. 1 and 2 lighting apparatuses comprising 3 fluorescent lighting fixtures each comprising fluorescent tubes are depicted. A light driver in the form of a fluorescent ballast (labeled as Dimming Ballast) is provisioned with internal circuitry to provide a voltage supply to energize a photo sensor and internal circuitry to read the photo sensor signal. The output of the photo sensor is used to adjust the level which the light driver energizes the connected fluorescent tubes to affect light output. FIG. 1 specific depicts fluorescent lighting fixtures, but the same concept applies to other dimmable lighting technologies such as induction lights or solid state lights (SSL). For example, in the case of a SSL lighting fixture where the fluorescent tubes are replaced by light emitting diodes (LED) and the light driver is replaced by a dimmable LED driver (which may be alternatively referred to as LED power supply), the remaining circuitry of the daylight control would apply unchanged and would work in the same fashion as with the fluorescent lighting fixture.

In the approach illustrated by FIG. 1, each lighting apparatus comprises a lighting fixture with an attached photo sensor to measure the surrounding ambient light level. Each lighting apparatus also functions autonomously and independently to all other lighting apparatus. In the event said lighting apparatus is in a location without natural ambient light, the photo sensor would be useless but yet the lighting apparatus would still carry the cost of the photo sensor. Additionally, in the system depicted in FIG. 1 the dimming function cannot be adjusted by other centralized controlling devices such as a manually operated dimming switch or a computer to automate light level control given the fixture by fixture control scheme.

In the scheme depicted in FIG. 1 each lighting apparatus could illuminate at a different brightness level compared to other nearby lighting apparatus due to the slight differences in the local ambient light level. This could be very distracting to human users of the illuminated space.

The scheme where the light driver such as a fluorescent ballast with integrated photo sensor circuitry is likely to be costly, limited in dimming functions to only “daylight control”, and unable to insure neighboring lighting apparatus will be similarly energized to produce uniform light level.

It will be demonstrated that the present invention solves the shortcomings of a lighting fixture with a light driver (e.g. fluorescent ballast) with integrated photo sensor circuitry and connected to a photo sensor mounted to the lighting apparatus.

FIG. 2 shows a scenario common in the current state of the art where a light driver, herein depicted in the form of a fluorescent ballast (labeled Dimming Ballast), has the internal circuitry to support an attached occupancy sensor in addition to a photo sensor. This further complicates the light driver with additional circuitry. Additional power capacity from a built-in power supply is needed to energize the occupancy sensor in addition to the photo sensor, and the light driver must be imbued with the ability to read the state of the occupancy sensor. This additional degree of integration requires the light driver to, in addition to its core function of energizing the lighting fixture, also support all the necessary input and output wiring connections within a very small form factor. Moreover, in order for the light driver to be able to support different light sources such as fluorescent, light emitting diode (LED), and induction light sources, the light driver, e.g. ballast, must be customized to incorporate the occupancy sensor circuitry and wireless processing if the occupancy sensor is to also control other lighting fixtures in the lighting zone. (For purposes of this specification, a group of lighting apparatuses controlled by a single photo sensor is referred to as a lighting zone.) An off-the-shelf light driver will not be capable of performing all these functions and therefore cannot be used which increases system cost.

It will be demonstrated that the present invention also resolves these issues via incorporating within a lighting zone a wireless control module with the circuitry and programming to interface with an occupancy sensor and photo sensor which would be compatible with a broad array of off-the-shelf light drivers and would be an improvement over the current state of the art.

Additional shortcomings of the present art of lighting fixtures comprising a light driver with integrated photo sensor circuitry include the following problems with incorporating the sensor interface functions within a light driver without use of a wireless control module:

each light fixture would need a photo sensor, occupancy sensor, or both, which would increase cost of the lighting fixture;
lighting fixtures belonging to the same lighting zone could be illuminated at a different brightness level due to local differences in ambient light level detected by each lighting fixture's photo sensor;
each light driver to be used with a different light source (e.g. LED light or an induction light driver) will need to be customized to incorporate the sensor interface circuitry before the lighting fixture can be used;
a photo sensor, occupancy sensor, or combination could not be shared across a lighting zone of lighting fixtures but must be duplicated for each lighting fixture because each lighting fixture would have the photo sensor or occupancy sensor built in;
and the lighting fixtures are incompatible with manual zone (e.g. centralized) level dimming using a manual control device (e.g. wall switch) or automated zone level dimming using a computer.

It will be demonstrated that the present invention solves these problems.

The novelty of this invention is to use a wireless control module to interface to a photo sensor and to transmit the output of the photo sensor or a derived control signal to other wireless control modules connected to additional light drivers configured to be in the same lighting zone.

By using a wireless control module incorporating photo sensor support circuitry to control a light driver rather than connecting the photo sensor support circuitry directly to the light driver, the wireless control module can be paired with different light drivers such as a light emitting diode (LED) light driver or an induction light driver, without first embedding the photo sensor support circuitry into the light driver. This allows the wireless control module to be compatible with off-the-shelf light drivers and lighting fixtures rather than requiring custom and substantially more expensive light drivers with built in photo sensor circuitry.

The use of separate wireless control modules also provides a much more flexible and widely applicable approach to zone lighting which allows a zone of lighting fixtures to be controlled by a single photo sensor which further allows all the lighting fixtures in the lighting zone to provide the same illumination level.

A separate photo sensor with a wireless control module will also allow for novel placement of the photo sensor. Traditional installation is to locate a lighting fixture in the ceiling. A photo sensor integrated into the lighting fixture must by default be located in the ceiling plane with the lighting fixture (although it is possible for the photo sensor to be located on the wall for lighting fixtures designed to be wall mounted). This precludes the possibility of locating the photo sensor on the working surface such as a desktop or tabletop in an office zone or on or near the floor in a corridor or walk path zone.

Locating the photo sensor on the working surface would have the benefit of detecting the lighting illumination level directly at the working surface and, by controlling the light output of the lighting fixture based on the illumination at the lighting surface, delivering the exact illumination level desired for the working surface. A photo sensor installed in the ceiling or wall could only control the approximate or averaged illumination level for the entire light zone or space. A photo sensor located on a working surface, in addition, would allow for more précised control of illumination level directly on the working surface, such as ensuring a desktop would be provided with 50 foot-candle of illumination or the floors in a hallway are illuminated to 30 foot-candle.

### SUMMARY OF THE INVENTION

In FIG. 3 one preferred embodiment of the present invention is depicted. A room which receives natural daylight through an aperture such as a window 800 is represented. In the room, a series of lighting apparatuses 200, 300, 400, each comprising a light driver 210, 310, 410 (fluorescent ballast labelled Dimming Ballast), a fluorescent light tube 220, 320, 420, and a wireless control module 230, 330, 430 are depicted. A photo sensor 240 with circuitry separate from that of the light driver 210 is incorporated into the first lighting apparatus 200 and the photo sensor circuitry is incorporated into the first wireless control module 230. The wireless control module 230 has built-in circuitry and programming to read the photo sensor 240 output and is capable of providing a dimming control signal to the light driver 210 according to a preprogrammed algorithm. Additionally, the wireless control module 230 may transmit the photo sensor 240 output or a control signal derived from the photo sensor 240 output to other lighting apparatuses 300, 400 with wireless control modules 330, 430 connected to light drivers 310, 410 which drive fluorescent light tubes 320, 420. In this fashion a group of lighting apparatuses 200, 300, 400 are controlled by a single photo sensor 240 via the wireless control modules 230, 330, 430 which transmit an identical dimming control signal to each light driver 210, 310, 410 to insure uniform light output is produced by each fluorescent tube 220, 320, 420.

In a preferred embodiment, the wireless control module 230 may also provide the necessary power supply required by the photo sensor 240, such as a 12 VDC power supply or a 24 VDC power supply, to energize the photo sensor 240.

Various preferred embodiments of the present invention will be shown to provide the following features.

Each preferred embodiment will comprise a wireless control module to be installed within a lighting fixture or installed external to the lighting fixture but in the range of the wireless modules in the same lighting zone, wherein the wireless control module will form a localized wireless network representing a lighting zone and the wireless control module will have a power supply to energize a photo sensor, the voltage of such to be 12 VDC, 24 VDC, or other voltage such as is customary where the system will be installed and used.

The wireless control module incorporating supporting circuitries for photo sensor and occupancy sensor would serve as the “coordinator” of the wireless network formed with other wireless modules. In FIG. 3 the wireless module labeled 230 would serve as the coordinator (which is readily understood by practitioners skilled in wireless networking) responsible for network creation, control of its parameters and basic maintenance, and connecting wireless modules labeled 330 and 430 into a wireless network. The benefit of this approach is eliminating the need for a separate wireless network coordinator required for a wireless network such as Zigbee.

The wireless control module will be able to read the output of the photo sensor measuring ambient light level and the wireless control module will be equipped to transmit the photo sensor output or a control value derived from the photo sensor to other wireless control modules configured to be in the same lighting zone.

The wireless control module may have sufficient power supply capacity to energize an occupancy sensor, the voltage of such to be 12 VDC, 24 VDC, or other voltage such as is customary where the system will be installed and used. If the wireless control module is installed in a lighting system which includes an occupancy sensor, the wireless control module will be able to read the output of the occupancy sensor installed to detect the presence or absence of inhabitants in the lighting zone and the wireless control module will be capable of transmitting that occupancy sensor output or a control value derived from the occupancy sensor to other wireless control modules configured to be in the same light zone.

The wireless control module may also be connected to a user interface device to allow a user to manually adjust the light output of a lighting zone by transmitting the manual settings to other wireless control modules configured to be in the same lighting zone.

The wireless control module may also be connected to a computer or other automated controller to automatically adjust the light output of a lighting zone by transmitting the automated brightness settings to other wireless control modules configured to be in the same light zone.

The wireless control module and photo sensor may also be installed ‘inverted’ compared to ceiling or fixture located photo sensor on the working surface (e.g. desktop, table top, floor, etc.) to directly control the illumination of the lighting fixtures in the same light zone to deliver the desired level of illumination.

### BRIEF DESCRIPTION OF THE DRAWINGS

Embodiments of the present invention will be described by reference to the following drawings, in which like numerals refer to like elements, and in which:

FIGS. 1 and 2 depict hard wired lighting systems;

FIG. 3 depicts an exemplary wireless lighting system using a photo sensor;

FIG. 4 depicts an exemplary wireless control module for a lighting system;

FIG. 5 depicts an exemplary wireless lighting system using a photo sensor and an occupancy sensor;

FIG. 6 depicts an exemplary wireless control module for a lighting system;

FIG. 7 depicts various examples of the light driver interfaces for dimming control;

FIG. 8 depicts the ON/OFF control of 0-10V compatible light driver where 0V or 10V do not correspond to zero light level output;

FIG. 9 depicts an exemplary wireless lighting system with a photo sensor and an occupancy sensor with a centralized control device for the manual adjustment of light output for all the lighting fixtures located in a single lighting zone;

FIG. 10 depicts an exemplary wireless lighting system with a photo sensor and an occupancy sensor with a centralized computer control device for the automated control of light output for all the light fixtures in a single lighting zone;

FIG. 11 depicts an exemplary wireless lighting system using a photo sensor that is located on a lighting fixture;

FIG. 12 depicts an exemplary wireless lighting system using a photo sensor that is located on representative working surfaces;

FIG. 13 depicts a flow chart for a method for wirelessly using a photo sensor within a lighting system;

FIG. 14 depicts a flow chart for a method for wirelessly using an occupancy sensor within a lighting system;

FIG. 15 depicts a flow chart for a method for wirelessly using a photo sensor and a computerized controller within a lighting system; and

FIG. 16 depicts a flow chart for a method for wirelessly using a photo sensor with a manual override within a lighting system.

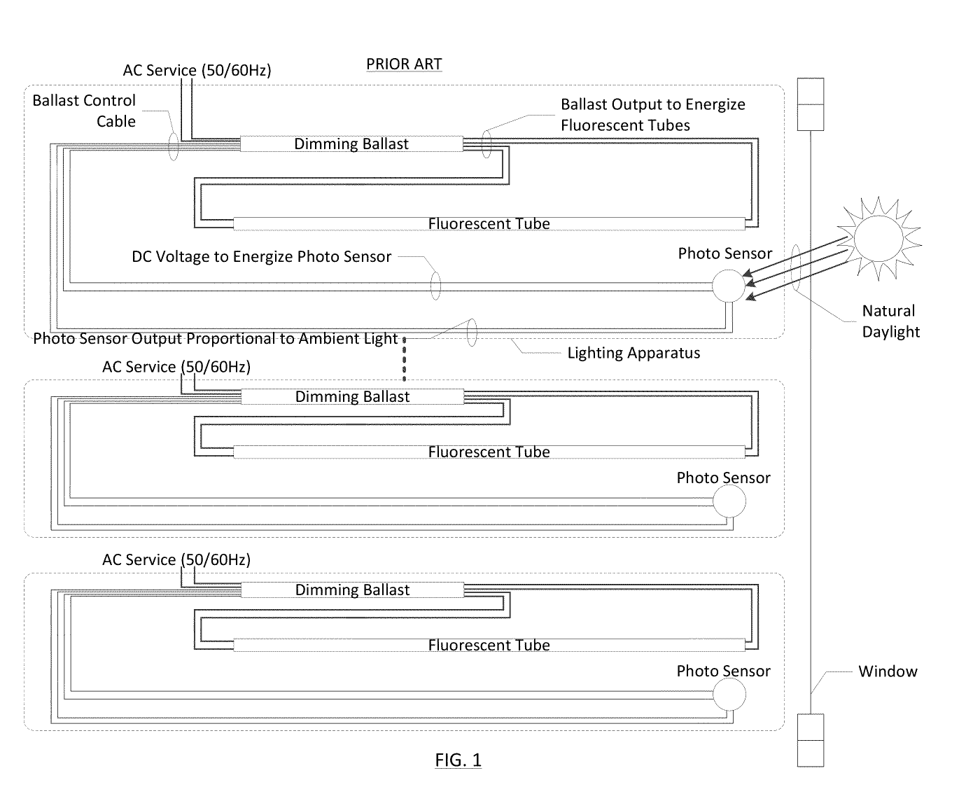

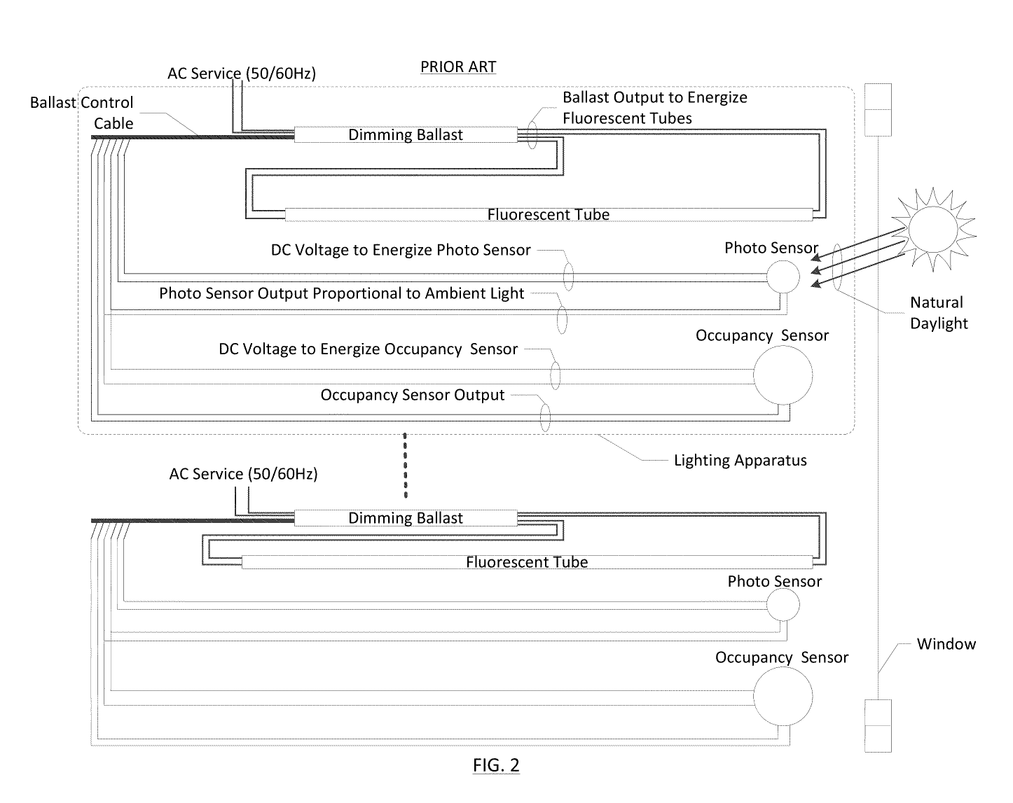

### DETAILED DESCRIPTION OF THE INVENTION

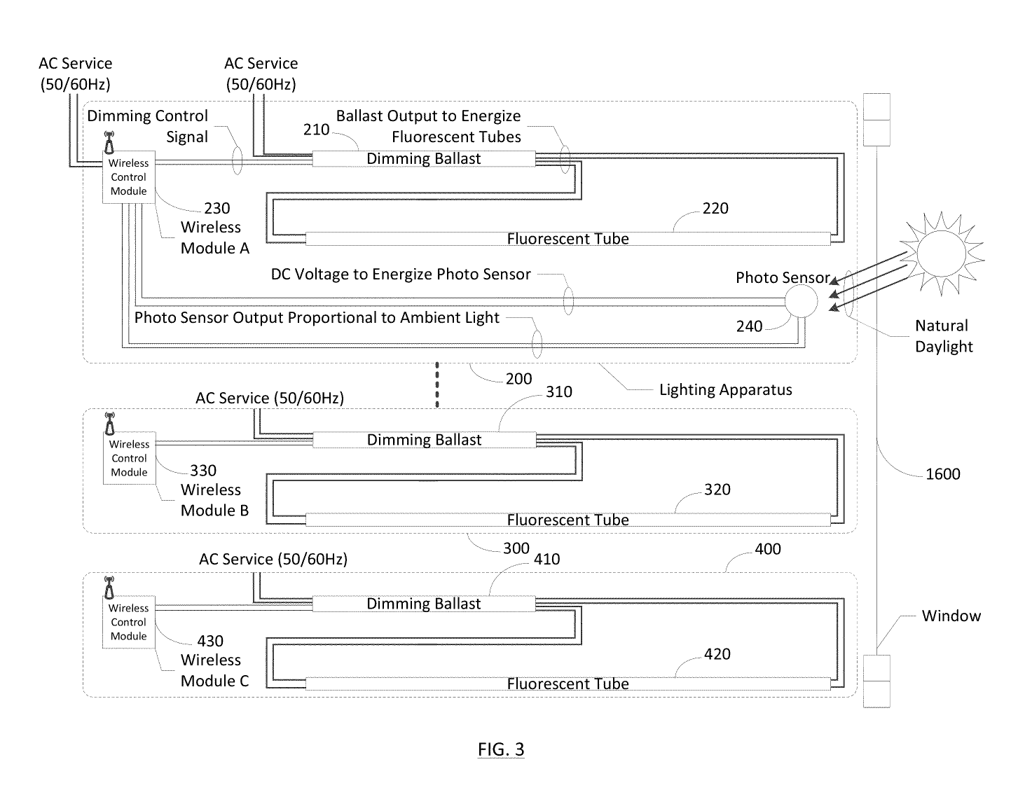

Referring to FIG. 3 a preferred embodiment of an exemplary lighting control system 200 for daylight control is depicted. As stated above, Daylight Control is a method of adjusting light output of Lighting Fixtures according to the output of a Photo Sensor measuring natural ambient light levels.

In the preferred embodiment depicted in FIG. 3, the power to run lighting apparatuses and controllers is supplied externally and may be either 120V (at 50 or 60 Hz) or 277V (at 50 or 60 Hz). In other embodiments, the power supplied to the unit may be at different levels due to either voltage or current levels differing based upon local conditions, including battery powered. A room which receives natural daylight through an aperture such as a window 1600 is represented in FIG. 3. In the room, a series of lighting apparatuses 200, 300, 400, each comprising at least one light driver 210, 310, 410 (fluorescent ballast labelled Dimming Ballast), at least one light source (e.g. a fluorescent light tube) 220, 320, 420, and a wireless control module 230, 330, 430 are depicted. It should be noted that the choice of three lighting apparatuses was made for ease of description and that the present teachings are applicable for systems with other quantities of lighting apparatuses. A photo sensor 240 with circuitry separate from that of the light driver 210 is incorporated into the first lighting apparatus 200 and the photo sensor circuitry is incorporated into the first wireless control module 230. The wireless control module 230 has built-in circuitry and programming to read the photo sensor 240 output and is capable of providing a dimming control signal to the light driver 210 according to a preprogrammed algorithm. The connection to the light driver is a control signal where it will affect the brightness of the light source in a predictable and repeatable fashion.

Additionally, the wireless control module 230 may transmit the photo sensor 240 output or a control signal derived from the photo sensor 240 output to other lighting apparatuses 300, 400 with wireless control modules 330, 430 connected to light drivers 310, 410 which drive fluorescent light tubes 320, 420. In this fashion a group of lighting apparatuses 200, 300, 400 are controlled by a single photo sensor 240 via the wireless control modules 230, 330, 430 which wirelessly transmit an identical dimming control signal to each light driver 210, 310, 410 to insure uniform light output is produced by each light source 220, 320, 420.

In a preferred embodiment, the wireless control module 230 may also provide the necessary power supply required by the photo sensor 240, such as a 12 VDC power supply or a 24 VDC power supply, to energize the photo sensor 240.

FIG. 3 depicts the wireless control module 230 providing a DC voltage to energize the photo sensor 240 and has circuitry and programming to interpret the output of the photo sensor.

In the preferred implementation of the claimed invention depicted in FIG. 3, the wireless control module 230 is provisioned to support the photo sensor 240 by providing suitable voltage to energize the photo sensor 240 and also to read and interpret the photo sensor 240 output. The same wireless control module 230 also has a mechanism to derive a dimming control signal based on the value of the photo sensor 240 output to adjust the brightness output of the light source 220. The photo sensor 240 detects the level of natural ambient light available in the lighting zone. When the ambient light level is high the output of the light source 220 is dimmed, and when the ambient light level is low the output of the light source 220 is increased. Wireless control modules 330, 430 connected to additional light drivers 310, 410 are provided with the photo sensor signal or a derived control value wirelessly via wireless control module 230. These wireless control modules 230, 330, 430 are preconfigured to belong to the same lighting zone.

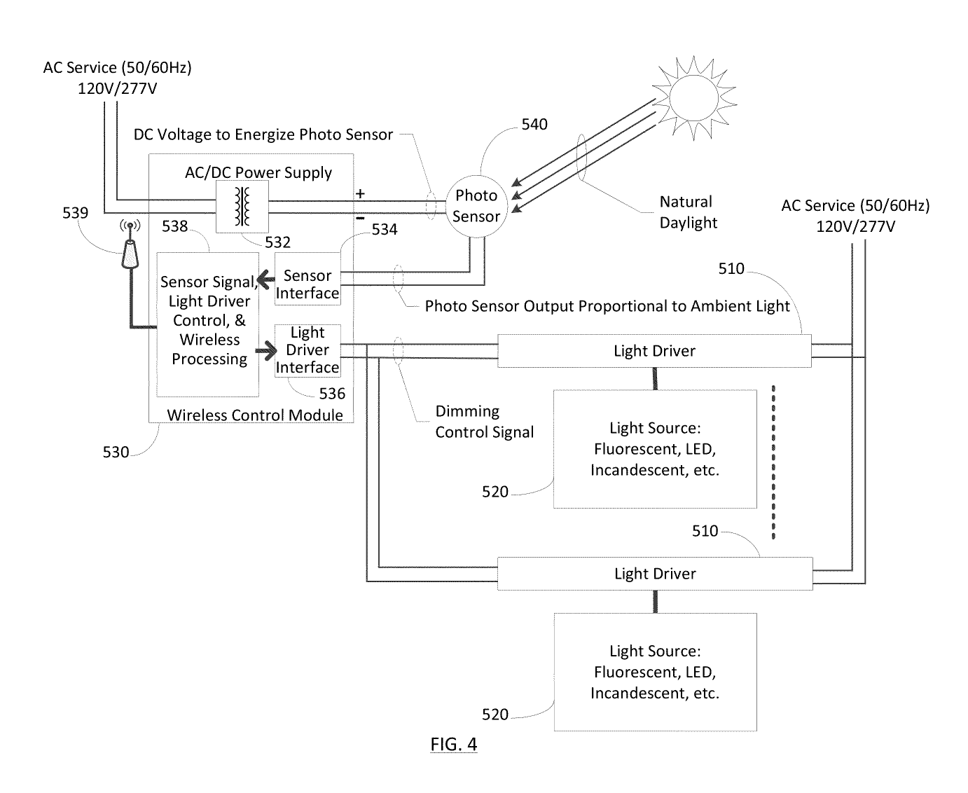

FIG. 4 illustrates the internal functional elements of a wireless control module 530. These internal functional elements include an AC to DC power supply 532 (which may be battery operated), a photo sensor interface 534, a light driver interface 536 and a functional module 538 to process the sensor signal, light driver control signal and wireless communications, and a wireless transmitter 539. This wireless control module 530 may be used to wirelessly control the light output of all lighting apparatuses in a single lighting zone based upon the input of a single photo sensor 540. The photo sensor 540 detects ambient light levels in a single lighting zone and transmits a signal to the functional module 538 via the photo sensor interface 534. The functional module 538 uses preprogrammed algorithms to determine the appropriate light output level and communicates this appropriate level to the light drivers 510 via the light driver interface. The light drivers 510 control the light sources 520 and the appropriate lighting level is produced. The wireless control module 539 may communicate with other wireless control modules controlling other lighting apparatuses in the same lighting zone to allow for all lighting apparatuses to output the correct lighting level required for the ambient light levels present in the lighting zone.

The AC to DC power supply provides the voltage to energize one or more Photo Sensors. The interface input circuitry (sensor interface) and programming are designed to read the output of the photo sensor and to interpret the measured natural ambient light level. The interface output circuitry and programming are designed to control the output of at least one light driver. The preprogrammed algorithm uses photo sensor measured ambient natural light level in the lighting zone to determine the control signal to transmit to at least one light driver. The wireless circuitry and programming are used to transmit photo sensor output or derived control value to other wireless control modules configured to operate in the same light zone. The wireless control modules connected to light drivers and light sources are configured to be operate in the same light zone and are the light sources are lit in unison to the common photo sensor output.

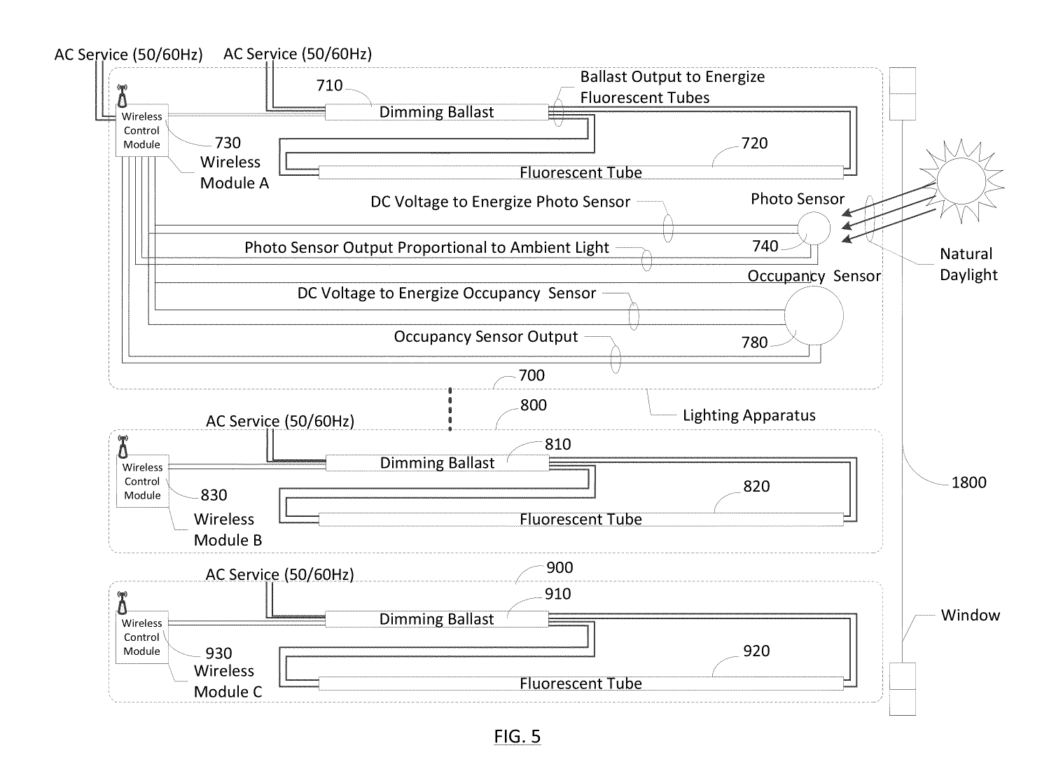

In the preferred embodiment depicted in FIG. 5, the power to run lighting apparatuses and controllers is supplied externally and may be either 120V (at 50 or 60 Hz) or 277V (at 50 or 60 Hz). In other embodiments, the power supplied to the unit may be at different levels due to either voltage or current levels differing based upon local conditions, including battery powered.

A room which receives natural daylight through an aperture such as a window 1800 is represented in FIG. 5. In the room, a series of lighting apparatuses 700, 800, 900, each comprising at least one light driver 710, 810, 910 (fluorescent ballast labelled Dimming Ballast), at least one light source 720, 820, 920, and a wireless control module 730, 830, 930 are depicted. A photo sensor 740 with circuitry separate from that of the light driver 710 is incorporated into the first lighting apparatus 700 and the photo sensor circuitry is incorporated into the first wireless control module 730. An occupancy sensor 750 with circuitry separate from that of the light driver 710 is incorporated into the first lighting apparatus 700 and the occupancy sensor circuitry is incorporated into the first wireless control module 730. In a preferred embodiment of the present invention, the occupancy sensor may be located on a wall within the light zone; in another preferred embodiment of the present invention, the occupancy sensor may be located on a ceiling within the light zone. The wireless control module 730 has built-in circuitry and programming to read the photo sensor 740 output and the occupancy sensor 750 output and is capable of providing a dimming control signal to the light driver 710 according to a preprogrammed algorithm. Additionally, the wireless control module 730 may transmit the photo sensor 740 output or a control signal derived from the photo sensor 740 output to other lighting apparatuses 800, 900 with wireless control modules 830, 930 connected to light drivers 810, 910 which drive fluorescent light tubes 820, 920. The wireless control module 730 may also transmit the occupancy sensor 750 output or a control signal derived from the occupancy sensor 750 output to other lighting apparatuses 800, 900 with wireless control modules 830, 930 connected to light drivers 810, 910 which drive fluorescent light tubes 820, 920. In this fashion a group of lighting apparatuses 700, 800, 900 are controlled by a single photo sensor 740 and a single occupancy sensor 750 via the wireless control modules 730, 830, 930 which wirelessly transmit an identical dimming control signal to each light driver 710, 810, 910 to insure uniform light output is produced by each fluorescent tube 720, 820, 920.

In a preferred embodiment, the wireless control module 730 may also provide the necessary power supply required by the photo sensor 740, such as a 12 VDC power supply or a 24 VDC power supply, to energize the photo sensor 740 and the occupancy sensor 750.

In the preferred embodiment of the present invention depicted in FIG. 5 the wireless control module 730 is additionally provisioned to work with the occupancy sensor 750 by providing additional power supply capacity to energize the occupancy sensor 750 and also are provided with the circuitry and programming to read and interpret the output of the occupancy sensor 750. The wireless control module 730 also has a mechanism to derive a control signal based on the state of the occupancy sensor 750 output to turn the light source 7200N or OFF via a signal sent to the light driver 710. The occupancy sensor 750 detects the presence or absence of inhabitants in the lighting zone. Wireless control modules 830, 930 connected to additional light drivers 810, 910 are also provided with the occupancy sensor 750 signal or a derived control value wirelessly via the first wireless control module 730 to energize or extinguish the light sources 820, 920 accordingly via the light drivers 810, 910. These wireless control modules 730, 830, 930 are preconfigured to belong to the same lighting zone.

FIG. 5 depicts the wireless control module 730 providing a DC voltage to energize the photo sensor 740 and the occupancy sensor 750 and has circuitry and programming to interpret the output of the photo sensor 740 and of the occupancy sensor 750.

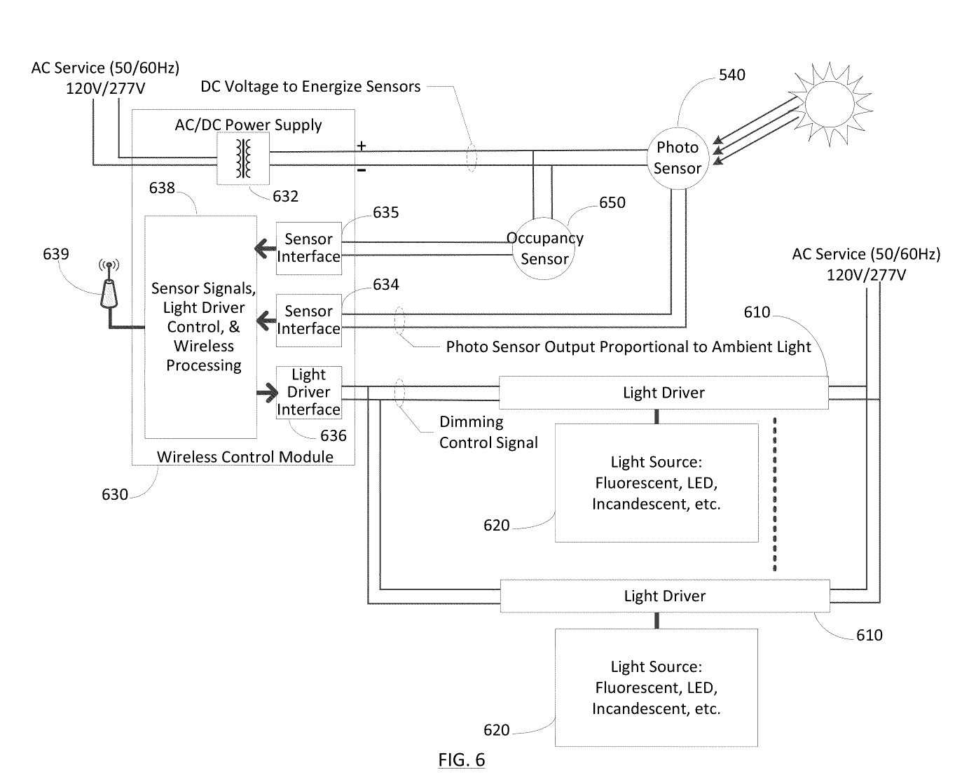

As depicted in FIG. 6, a wireless control module 630 can be extended to incorporate support for an occupancy sensor 650. The occupancy sensor 650 detects the presence or absence of inhabitants in the lighting zone. In the event that inhabitant presence is detected, the state of the occupancy sensor 650 would change and forward a signal to the wireless control module 630 via an occupancy sensor interface 635. In turn the wireless control module would dispatch a control signal via a light driver interface 636 to light drivers 610 to energize light sources 620 to an illumination level appropriate to the ambient light level detected by a photo sensor 650. When the occupancy sensor 650 detects lack of inhabitant presence the sensor state would again change accordingly and a signal would be sent to the wireless control module 630 via the occupancy sensor interface 635. The wireless control module 630 receiving indication of a lack of presence would dispatch a control signal via the light driver interface 636 to the light drivers 610 to turn off the light sources 620 regardless of the photo sensor 640 output sent to the wireless control module 630 via a photo sensor interface 634. The wireless control module 630 is able to interpret the occupancy sensor 650 output and energize or extinguish the light source 620 via a signal to the light driver 610 depending on the occupancy state of the lighting zone.

The wireless control module 630 will transmit the occupancy sensor 650 output or a control value derived from the occupancy sensor 650 output to other wireless control modules configured to be in the same lighting zone and affects the ON/OFF status of lighting fixtures in the lighting zone

Furthermore, if in the lighting zone there other light drivers controlled by additional wireless control modules, the wireless control module 630 would transmit the state of the occupancy sensor 650 to the other wireless control modules installed in the lighting zone so all lighting fixtures in the entire lighting zone would be similarly controlled and the light output from the lighting fixtures would be of a consistent and compatible level. In this fashion the occupancy sensor 650 is able to control an entire lighting zone of lighting fixtures wirelessly.

The AC to DC power supply provides the voltage to energize one or more Photo Sensors. The photo sensor interface input circuitry (photo sensor interface) and programming are designed to read the output of the photo sensor and to interpret the measured natural ambient light level. The occupancy sensor interface circuitry and programming are designed to read the output of the occupancy sensor. The interface output circuitry and programming are designed to control the output of at least one light driver. The preprogrammed algorithm uses photo sensor measured ambient natural light level in the lighting zone and occupancy sensor output to determine the control signal to transmit to at least one light driver. The wireless circuitry and programming are used to transmit photo sensor output or derived control value and occupancy sensor output or derived control value to other wireless control modules configured to operate in the same light zone. The wireless control modules connected to light drivers and light sources are configured to be operate in the same light zone and are the light sources are lit in unison to the common photo sensor and occupancy sensor outputs.

A wireless control module with the circuitry and programming to interface with an occupancy sensor and photo sensor would be compatible with a broad array of off-the-shelf light drivers and is an improvement over the current state of the art.

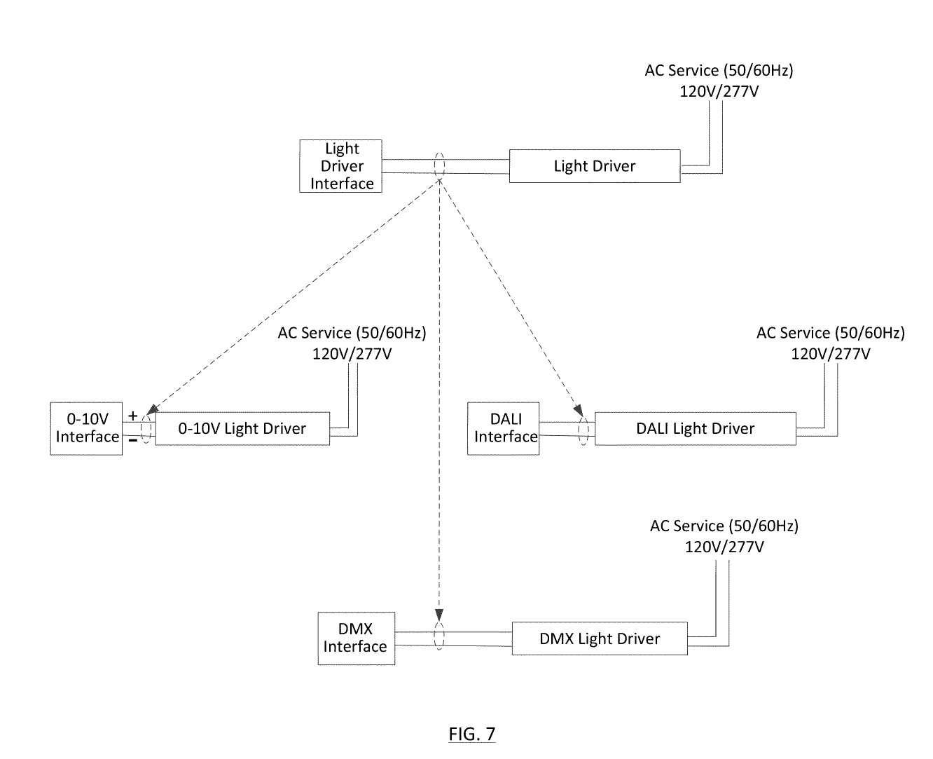

FIG. 7 shows examples of three industry standard light driver interfaces to communicate the dimming control signal. The examples include 0-10 Vdc interface, DALI (Digitally Addressable Lighting Interface) or DMX. Off-the-self light drivers compatible with one of these industry standards (as well as other popular interfaces) would be compatible with the wireless control module invention and could readily be fitted to be controlled via a wireless control module. Preferably the control signal is an industry standard interface such as 0-10 Vdc, DALI or DMX. As those skilled in the art will recognize, the present invention may be used with additional means for control signal. Furthermore for 0-10 Vdc control interface an additional relay control output may be required to completely extinguish the light source.

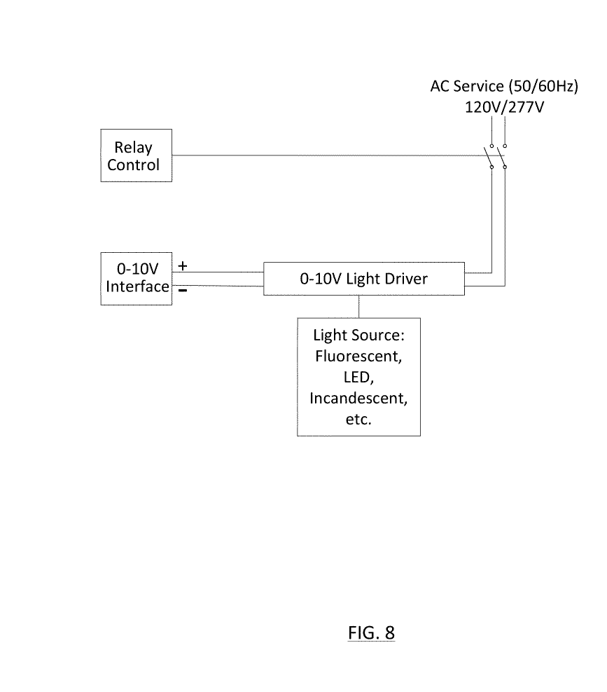

FIG. 8 shows an embodiment where the wireless control module may be used to provide relay control to a relay connected in series with a light driver's AC service input for a light driver controlled via a 0-10 Vdc control interface. The relay control is needed because industry standard 0-10 Vdc control does not require the light source to be at zero illumination output when the control is at 0 Vdc and though the conditions would call for the light source to provide zero illumination output, the light source could still be outputting light even when the control is at 0 Vdc. In this case a separate relay is needed to interrupt the power input to the light driver and extinguish the light source completely. The wireless control module may be programmed to provide this relay control.

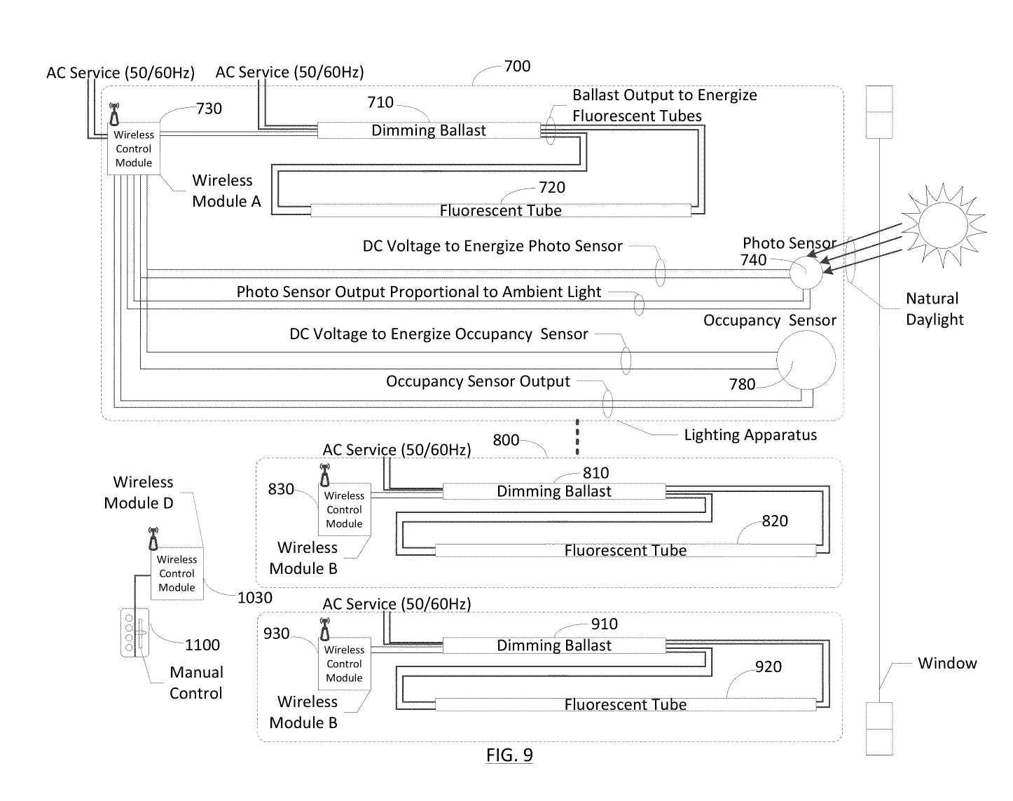

FIG. 9 illustrates another beneficial embodiment of the invention where a manual control device such as a wall switch or a scene controller is used with a wireless control module to allow for manual adjustment of the illumination level of lighting fixtures for a lighting zone. The wireless control module may incorporate circuitry and programming to read and interpret the manual control device. The wireless control module may transmit the manual setting from the manual control device to other wireless control modules configured to be in the same lighting zone.

In FIG. 9, the lighting system of FIG. 5 is depicted with the lighting system having an additional wireless control module 1030. The additional wireless control module 1030 is connected to a user interface device 1100 allowing manual adjustment of the output of the lighting fixtures 700, 800, 900 in the configured lighting zone. When a user attempts to manually control the output of the lighting fixtures 700, 800, 900 in the lighting zone, a signal is transmitted to wireless control module 1030 which wirelessly transmits the adjustment settings to the each of the other wireless control modules 730, 830, 930 in the same lighting zone. Each of the other wireless control modules 730, 830, 930 subsequently send signals to their controlled light drivers 710, 810, 910 to adjust the output of each light source 720, 820, 920 to the desired level.

In the preferred embodiment of the present invention depicted in FIG. 9, the wireless control module 1030 is connected to the manual control device 1100. Wireless control modules 730, 830, 930 connected to light drivers 710, 810, 910 are provided with the brightness setting or a derived control value wirelessly from the wireless control module 1030 connected to the manual control device 1100 and accordingly adjust the brightness output of the their light sources 720, 820, 920.

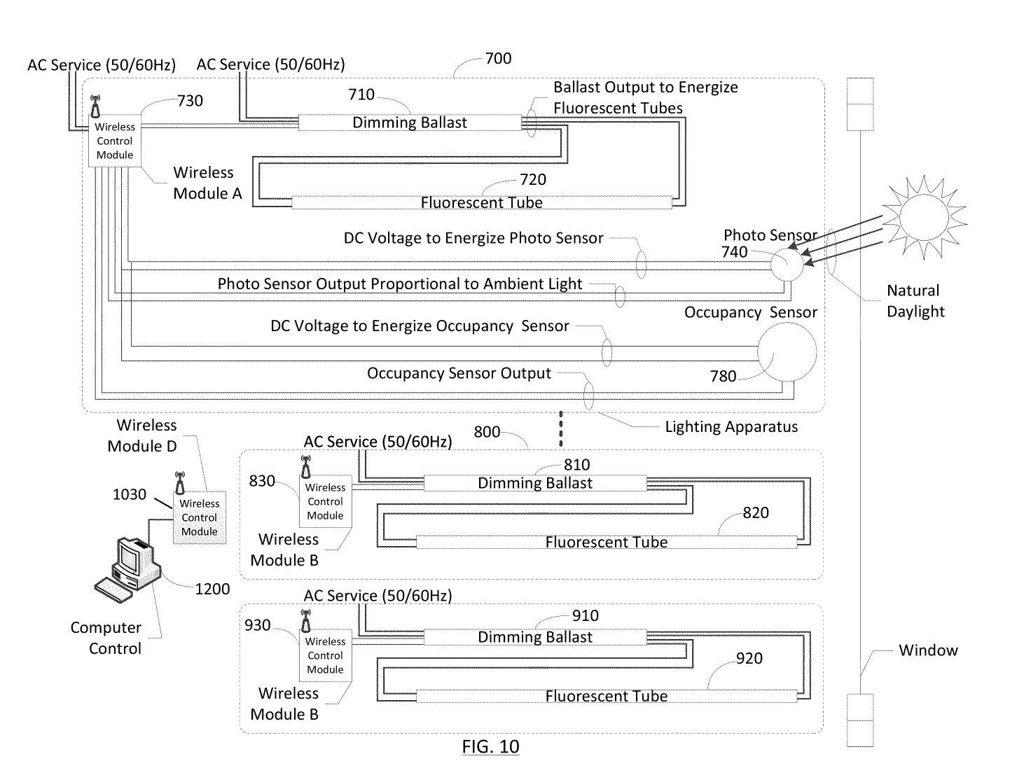

FIG. 10 illustrates another beneficial embodiment of the invention wherein a computerized control device 1200 such as a computer is added to wirelessly control the lighting zone. The wireless control module may incorporate circuitry and programming to read and interpret the computerized control device. The wireless control module may transmit the commands from the computerized control device to other wireless control modules configured to be in the same lighting zone.

In FIG. 10, the lighting system of FIG. 9 is depicted with a computerized control device 1200 replacing the manual control 1100. The wireless control module 1030 in FIG. 10 is connected to a computerized control device 1200 allowing lighting control to be automated. The computerized control device 1200 uses a preprogrammed algorithm to send signals to the wireless control module 1030 which communicates with the other wireless control modules 730, 830, 930. Each of the other wireless control modules 730, 830, 930 transmit signals to each light driver 710, 810, 910 which control the output of each lighting device 720, 820, 920.

In the preferred embodiment depicted in FIG. 10, the wireless control module 1030 is connected to a computerized control device 1200. Wireless control modules 730, 830, 930 connected to light drivers 710, 810, 910 are provided with the brightness setting or a derived control value wirelessly from the wireless control module 1030 connected to the computerized control device 1200 and accordingly adjust the brightness output of the their light sources 720, 820, 920.

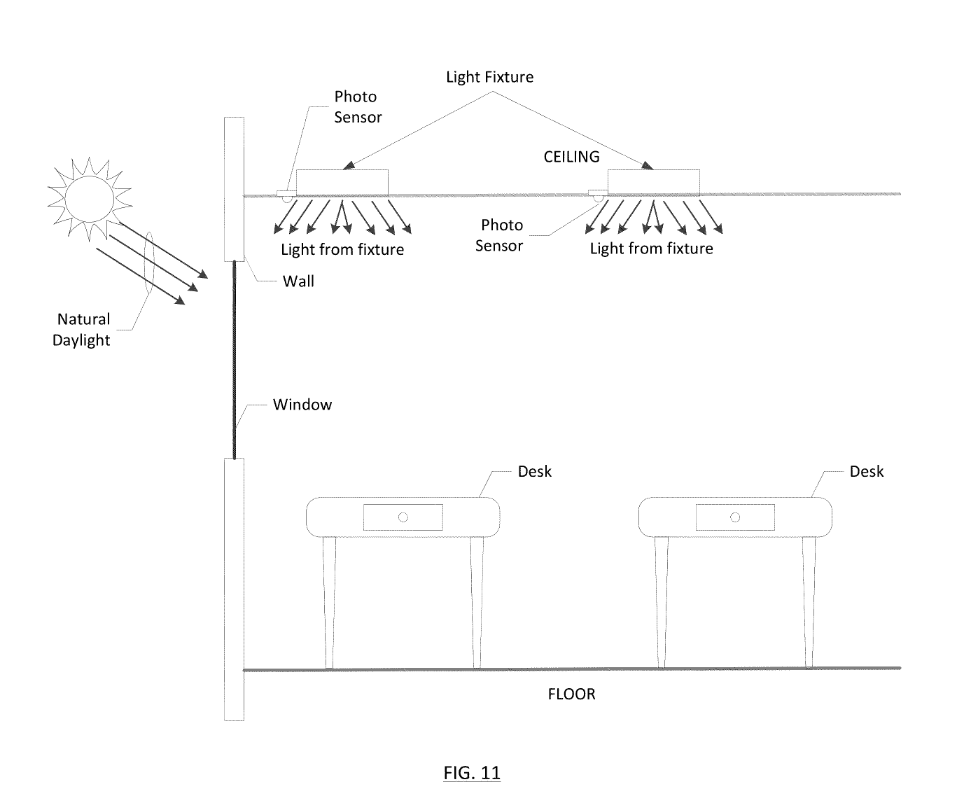

FIG. 11 presents a depiction of the layout for one preferred embodiment of the present invention. In FIG. 11, a room with a window for allowing natural daylight into the room, two desks for workstations, two light fixtures, and a photo sensor attached to one of the light fixtures is depicted. Using a control scheme such as that depicted in FIG. 3 allows for output from the single photo sensor to be used in determining and effecting the output of both light fixtures.

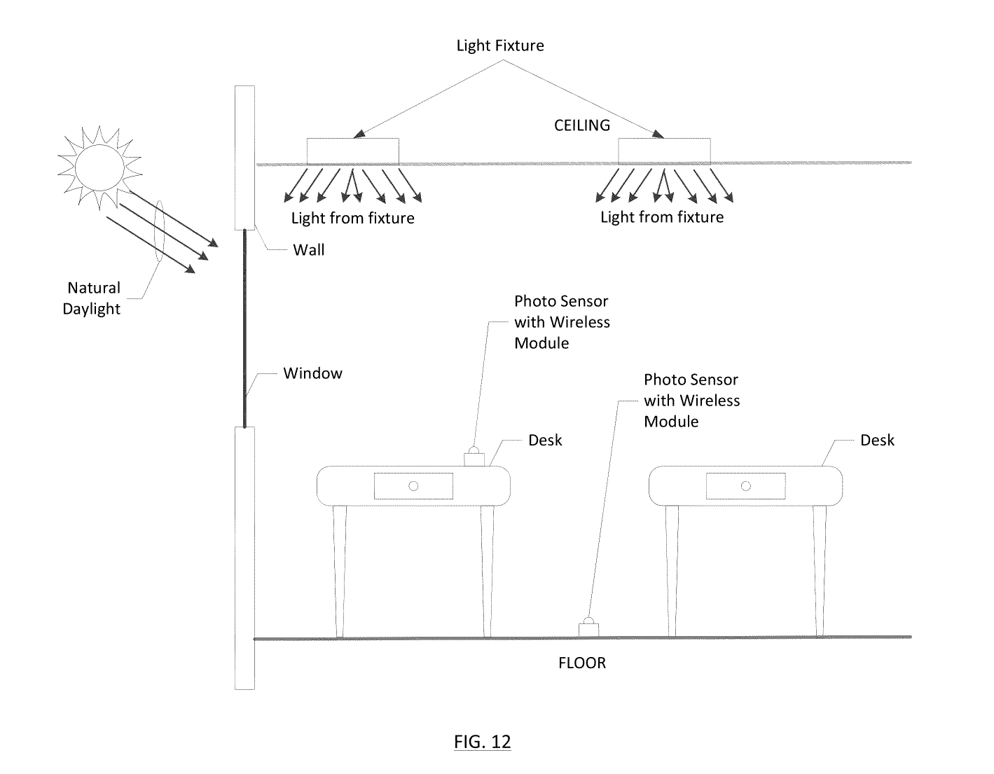

FIG. 12 presents a depiction of the layout for another preferred embodiment of the present invention. In FIG. 12, a room with a window for allowing natural daylight into the room, two desks for workstations, two light fixtures, and two representative photo sensors mounted on either the floor or a work station is depicted. Using a control scheme such as that depicted in FIG. 10 allows for output from either photo sensor to be used in determining and effecting the output of both light fixtures.

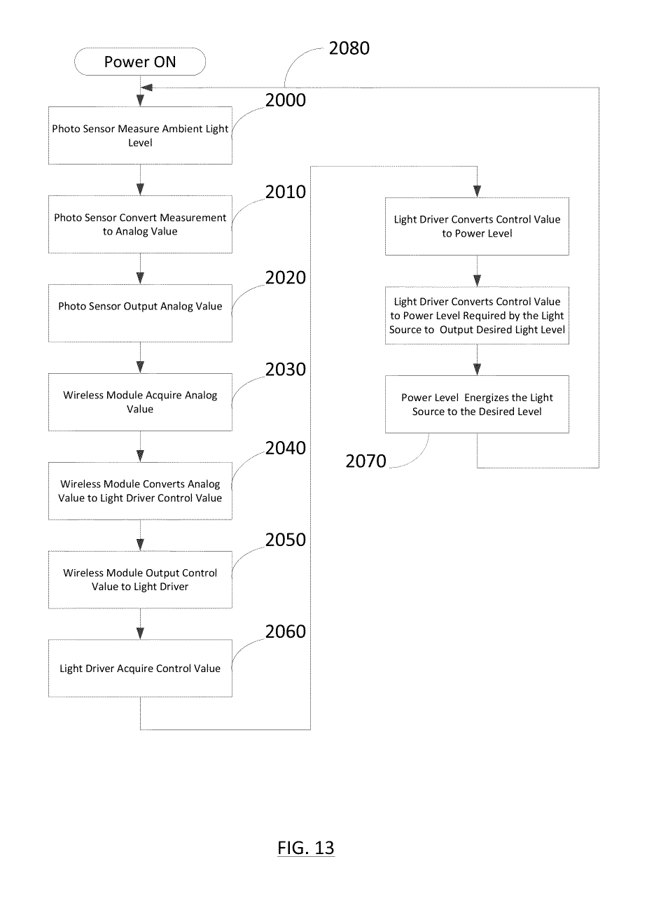

FIG. 13 presents a flow chart of the method used to wirelessly incorporate the photo sensor 240 into the lighting system depicted in FIG. 3. In step 2000 the photo sensor 240 detects and measures the ambient light level in the light zone. In steps 2010 and 2020 the photo sensor 240 converts the measured ambient light level to an analog representation of the ambient light level and outputs that analog value to the wireless control module 230. In steps 2030 and 2040 the wireless control module 230 receives the analog representation of the ambient light level and uses an algorithm to convert the analog value to a light driver control value. In step 2050 the wireless control module transmits the light driver control value to the light driver 210 and to the other wireless control modules 330, 430 in the light zone. Wireless control module 330 transmits the light driver control value to light driver 310 and wireless control module 430 transmits the light driver control value to light driver 410. In step 2060 the light drivers 210, 310, 410 receive the light driver control value, The light drivers 210, 310, 410 use an algorithm to convert the control value to a light source power level and transmit the light source power level to the light sources 220, 320, 420. In step 2070 the light sources 220, 320, 420 are adjusted to the appropriate output level. In step 2080 the process is repeated and the photo sensor 240 measures the ambient light level in the light zone.

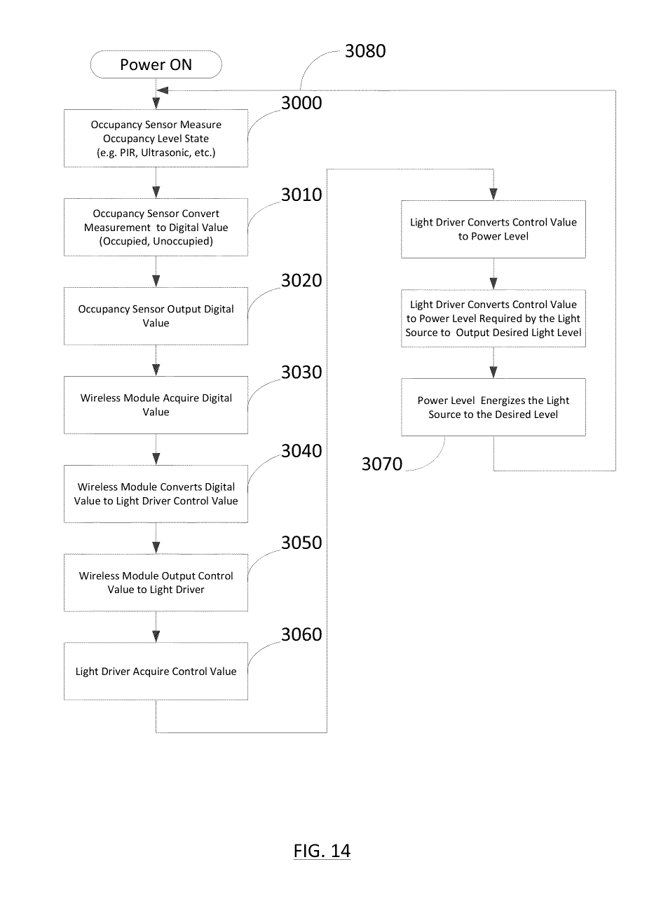

FIG. 14 presents a flow chart of the method used to wirelessly incorporate the occupancy sensor 780 into the lighting system depicted in FIG. 5. In step 3000 the occupancy sensor 780 detects whether the light zone is occupied. The occupancy sensor 780 may use any readily available means to detect occupancy in the light zone, such as passive infrared or by sound detection. In steps 3010 and 3020 the occupancy sensor 780 converts the measured occupancy state of the light zone to a digital value and outputs that digital value to the wireless control module 730. In steps 3030 and 3040 the wireless control module 730 receives the digital value from the occupancy sensor 780 and uses an algorithm to derive a light driver control value. In step 3050 the wireless control module transmits the light driver control value to the light driver 710 and to the other wireless control modules 830, 930 in the light zone. Wireless control module 830 transmits the light driver control value to light driver 810 and wireless control module 930 transmits the light driver control value to light driver 910. In step 3060 the light drivers 710, 810, 910 receive the light driver control value, The light drivers 710, 810, 910 use an algorithm to convert the control value to a light source power level and transmit the light source power level to the light sources 720, 820, 920. In step 3070 the light sources 720, 820, 920 are adjusted to the appropriate output level. In step 3080 the process is repeated and the occupancy sensor 780 measures the occupancy state in the light zone.

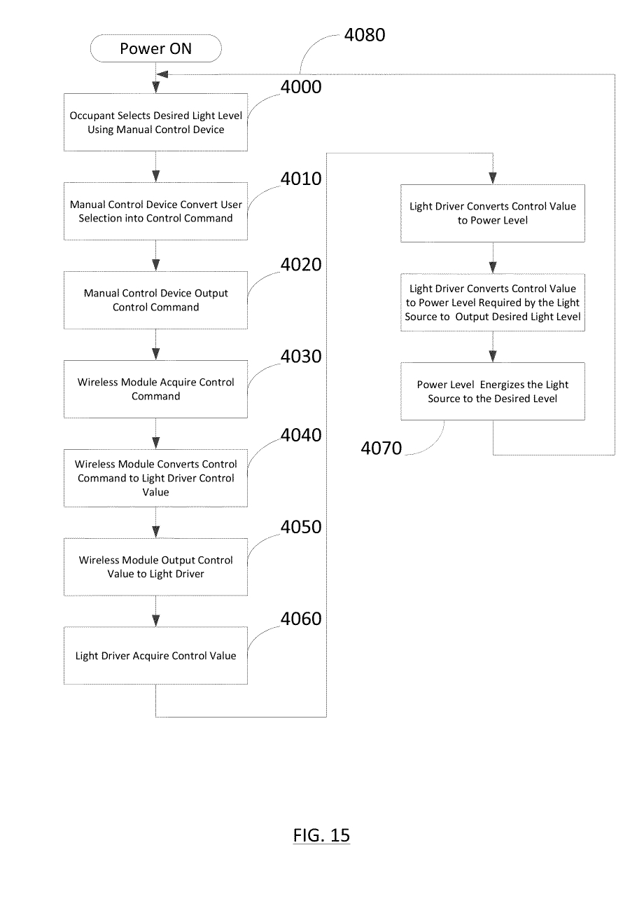

FIG. 15 presents a flow chart of the method used to wirelessly incorporate the user selected manual adjustment to the light input level into the lighting system depicted in FIG. 9. In step 4000 an individual located in or outside the light zone selects a desired light level for the light zone using the manual control device 1100. In steps 4010 and 4020 the manual control device 1100 converts the selected ambient light level to a control command and outputs that control command to the wireless control module 1030. In steps 4030 and 4040 the wireless control module 1030 receives the control command and uses an algorithm to convert the analog value to a light driver control value. In step 4050 the wireless control module 1030 transmits the light driver control value to the other wireless control modules 730, 830, 930 in the light zone. Wireless control module 730 transmits the light driver control value to light driver 710, wireless control module 830 transmits the light driver control value to light driver 810 and wireless control module 930 transmits the light driver control value to light driver 910. In step 4060 the light drivers 710, 810, 910 receive the light driver control value, The light drivers 710, 810, 910 use an algorithm to convert the control value to a light source power level and transmit the light source power level to the light sources 720, 820, 920. In step 4070 the light sources 720, 820, 920 are adjusted to the appropriate output level. In step 4080 the process is repeated and the manual control device 1100 is set or remains set at the desired user level.

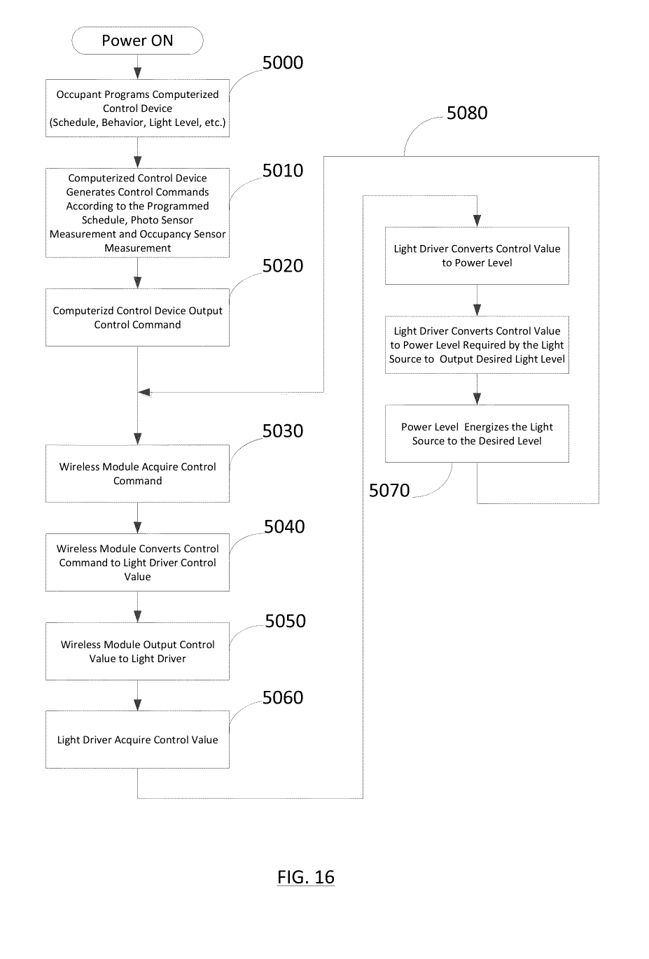

FIG. 16 presents a flow chart of the method used to wirelessly incorporate computer selected light output level for the light input level into the lighting system depicted in FIG. 10. In step 5000 an individual such as an occupant, technician or specialist programs a computerized control device 1200 to a desired light level for the light zone. The programming may be performed once, infrequently, or frequently. As those skilled in the art are aware, the frequency of adjusting the programming does not alter the novelty of the present invention. In steps 5010 and 5020 the computerized control device 1200 converts the selected ambient light level to a control command and outputs that control command to the wireless control module 1030. The command or sequence of commands may be outputted to satisfy the programming embodying the desired behavior of a single light zone or multiple light zones. In steps 5030 and 5040 the wireless control module 1030 receives the control command and uses an algorithm to convert the analog value to a light driver control value. In step 5050 the wireless control module 1030 transmits the light driver control value to the other wireless control modules 730, 830, 930 in the light zone. Wireless control module 730 transmits the light driver control value to light driver 710, wireless control module 830 transmits the light driver control value to light driver 810 and wireless control module 930 transmits the light driver control value to light driver 910. In step 5060 the light drivers 710, 810, 910 receive the light driver control value, The light drivers 710, 810, 910 use an algorithm to convert the control value to a light source power level and transmit the light source power level to the light sources 720, 820, 920. In step 5070 the light sources 720, 820, 920 are adjusted to the appropriate output level. In step 4080 the process is repeated and the wireless control module 1030 receives the control command.

Although several embodiments of the present invention, methods to use said, and its advantages have been described in detail, it should be understood that various changes, substitutions and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged lighting system.

I claim:

1. A method for wireless control of lighting fixtures configured to operate in the same light zone using a photo sensor with capability to output ambient light intensity wherein the lighting fixtures comprise at least one light driver and at least one light source, the method comprising:
means to energize the photo sensor;
means to interpret the photo sensor output;
means to derive a control signal based on the output of the photo sensor;
means to control the output of light drivers;
means to wirelessly transmit the photo sensor output or a derived control value to the lighting fixtures configured to operate in the same light zone.

2. The method of claim 1 wherein the means to interpret the derived control value and transmit the derived control value or the photo sensor output is embodied in a wireless control module.

3. The method of claim 1 wherein the wireless control module attached to the photo sensor is the coordinator of the wireless network.

4. The method of claim 1 wherein the photo sensor is located within the light zone and apart from the lighting fixtures.

5. The method of claim 4 wherein the photo sensor is located on a work surface in the light zone.

6. The method of claim 4 wherein the photo sensor is located on a floor in the light zone.

7. The method of claim 2 wherein the wireless control module comprises means to supply power to the photo sensor.

8. A method for wireless control of lighting fixtures configured to operate in the same light zone using an occupancy sensor with capability to output occupancy state of the light zone wherein the lighting fixtures comprise at least one light driver and at least one light source, the method comprising:
means to energize the occupancy sensor;
means to interpret the occupancy sensor output;
means to derive a control signal based on the output of the occupancy sensor;
means to control the on/off light levels of the light drivers corresponding to the occupancy state of the occupancy sensor;
means to control the output of light drivers;
means to wirelessly transmit the occupancy sensor output or a derived control value to the lighting fixtures configured to operate in the same light zone.

9. The method of claim 8 wherein the means to interpret the derived control value and transmit the occupancy sensor output or derived control value is embodied in a wireless control module.

10. The method of claim 9 wherein the wireless control module attached to the occupancy sensor and photo sensor is the coordinator of the wireless network.

11. The method of claim 10 wherein the wireless control module further comprises means to supply power to the occupancy sensor.

12. The method of claim 8 wherein the occupancy sensor is located within the light zone and apart from the lighting fixtures.

13. The method of claim 12 wherein the occupancy sensor is located on a wall within the light zone.

14. The method of claim 12 wherein the occupancy sensor is located on a ceiling within the light zone.

15. A method for wireless control of lighting fixtures configured to operate in the same light zone using a manual brightness user interface device, photo sensor, and occupancy sensor, wherein the lighting fixtures comprise at least one light driver and at least one light source, the method comprising:
means to energize the user interface device;
means to interpret the manual brightness setting of the user interface device;
means to derive a control signal based on the set point of the user interface device;
means to control the output of light drivers;
means to wirelessly transmit the derived control signal of the user interface device or a derived control value to the lighting fixtures configured to operate in the same light zone.

16. The method of claim 15 wherein the means to interpret and transmit the user interface device output is embodied in a wireless control module.

17. The method of claim 15 wherein the wireless control module attached to the user interface device is the coordinator of the wireless network.

18. The method of claim 16 wherein the wireless control module comprises means to supply power to the user interface device.

19. A method for wireless control of lighting fixtures configured to operate in the same light zone using a computerized control device wherein the lighting fixtures comprise at least one light driver and at least one light source, the method comprising:
means to interpret the computerized brightness setting of the control device;
means to derive a control signal based on the set point of the control device;
means to control the output of light drivers;
means to wirelessly transmit the set point of the control device or a derived control value to the lighting fixtures configured to operate in the same light zone.

20. The method of claim 19 wherein the means to interpret and transmit the computerized control device output is embodied in a wireless control module.

21. The method of claim 20 wherein the wireless control module attached to the computerized control device is the coordinator of the wireless network.

22. A system for wireless control of lighting fixtures configured to operate in the same light zone, the system comprising
at least one lighting fixture comprising a light driver and at least one light source,
a photo sensor, wherein said photo sensor has the capability to output a value representing the ambient light intensity and said photo sensor is located within the light zone and apart from the lighting fixtures,
and at least one wireless control module wherein said wireless control module comprises a functional module, a photo sensor interface, and a light driver interface.

23. The system of claim 22 further comprising an occupancy sensor wherein said occupancy sensor is located within the light zone and apart from the lighting fixtures.

24. The system of claim 22 further comprising a computerized control device.

25. The system of claim 22 further comprising a user interface device.
